(19) United States
(12) Patent Application Publication
(10) Pub. No.: US 2026/0067293 A1
(43) Pub. Date: Mar. 5, 2026

(54) METHODS, SYSTEMS, APPARATUSES, AND DEVICES FOR FACILITATING MANAGING TRAFFIC BETWEEN DEVICES AND ORIGIN SERVERS

(71) Applicant: Elad Rave, Walnut Creek, CA (US)

(72) Inventor: Elad Rave, Walnut Creek, CA (US)

(21) Appl. No.: 18/818,205

(22) Filed: Aug. 28, 2024

(51) Int. Cl. H04L 9/40

(52) U.S. Cl. CPC H04L 63/1416; H04L 63/029

(57) ABSTRACT

A method for facilitating managing traffic between devices and origin servers. The method includes receiving a request from a device, analyzing the request, determining a value of a parameter based on the analyzing of the request, identifying an edge server from edge servers based on the determining of the value of the parameter, configuring a first operational parameter associated with a traffic handling of the edge server based on the determining of the value of the parameter and the identifying of the edge server, and directing a traffic associated with the device to the edge server based on the configuring of the first operational parameter. The edge server is configured for handling the traffic between the device and an origin server based on the configuring of the first operational parameter and the directing of the traffic.

### FIELD OF THE INVENTION

Generally, the present disclosure relates to the field of data processing. More specifically, the present disclosure relates to methods, systems, apparatuses, and devices for facilitating managing traffic between devices and origin servers.

### BACKGROUND OF THE INVENTION

The field of data processing is technologically important to several industries, business organizations, and/or individuals. In particular, the use of data processing is prevalent for facilitating managing traffic between devices and origin servers.

Border gateway protocol (BGP) hijacking is a significant security issue in which an attacker, either intentionally or accidentally, causes internet traffic destined for a particular network (the origin) to be redirected to the attacker's network. This redirection can lead to various malicious activities, such as traffic interception, data manipulation, or denial of service to the legitimate network. Conventional methods to address border gateway protocol (BGP) hijacking often involve manual intervention, which can be slow and ineffective. Additionally, these methods may require significant changes to the existing network infrastructure, making them impractical for widespread deployment.

Existing techniques for facilitating managing traffic between devices and origin servers are deficient with regard to several aspects. For instance, current technologies do not mitigate a hijacking of at least a portion of the network that causes the redirection of the internet traffic. As a result, different technology is needed which mitigate this hijacking.

Therefore, there is a need for improved methods, systems, apparatuses, and devices for facilitating managing traffic between devices and origin servers that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating managing traffic between devices and origin servers, in accordance with some embodiments. Accordingly, the method may include a step of receiving, using a communication device, at least one request from at least one device. Further, the method may include a step of analyzing, using a processing device, the at least one request. Further, the method may include a step of determining, using the processing device, at least one value of at least one parameter based on the analyzing of the at least one request. Further, the method may include a step of identifying, using the processing device, at least one edge server from a plurality of edge servers based on the determining of the at least one value of the at least one parameter. Further, the method may include a step of configuring, using the processing device, at least one first operational parameter of the at least one edge server based on the determining of the at least one value of the at least one parameter and the identifying of the at least one edge server. Further, the at least one first operational parameter may be associated with a traffic handling of the at least one edge server. Further, the method may include a step of directing, using the processing device, at least one traffic associated with the at least one device to the at least one edge server based on the configuring of the at least one first operational parameter. Further, the at least one edge server may be configured for handling the at least one traffic between the at least one device and at least one origin server based on the configuring of the at least one first operational parameter and the directing of the at least one traffic.

Further, disclosed herein is a system for facilitating managing traffic between devices and origin servers, in accordance with some embodiments. Accordingly, the system may include a communication device configured for receiving at least one request from at least one device. Further, the system may include a processing device communicatively coupled with the communication device. Further, the processing device may be configured for analyzing the at least one request. Further, the processing device may be configured for determining at least one value of at least one parameter based on the analyzing of the at least one request. Further, the processing device may be configured for identifying at least one edge server from a plurality of edge servers based on the determining of the at least one value of the at least one parameter. Further, the processing device may be configured for configuring at least one first operational parameter of the at least one edge server based on the determining of the at least one value of the at least one parameter and the identifying of the at least one edge server. Further, the at least one first operational parameter may be associated with a traffic handling of the at least one edge server. Further, the processing device may be configured for directing at least one traffic associated with the at least one device to the at least one edge server based on the configuring of the at least one first operational parameter. Further, the at least one edge server may be configured for handling the at least one traffic between the at least one device and at least one origin server based on the configuring of the at least one first operational parameter and the directing of the at least one traffic.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method 200 for facilitating managing traffic between devices and origin servers, in accordance with some embodiments.

FIG. 3 is a flowchart of a method 300 for facilitating managing traffic between devices and origin servers, in accordance with some embodiments.

FIG. 4 is a flowchart of a method 400 for facilitating managing traffic between devices and origin servers, in accordance with some embodiments.

FIG. 5 is a flowchart of a method 500 for facilitating managing traffic between devices and origin servers, in accordance with some embodiments.

FIG. 6 is a flowchart of a method 600 for facilitating managing traffic between devices and origin servers, in accordance with some embodiments.

FIG. 7 is a block diagram of a system 700 for facilitating managing traffic between devices and origin servers, in accordance with some embodiments.

FIG. 8 is a block diagram of the system 700 for facilitating managing traffic between devices and origin servers, in accordance with some embodiments.

FIG. 9 is a block diagram of the system 700 for facilitating managing traffic between devices and origin servers, in accordance with some embodiments.

FIG. 10 is a block diagram of the system 700 for facilitating managing traffic between devices and origin servers, in accordance with some embodiments.

FIG. 11 is a block diagram of the system 700 for facilitating managing traffic between devices and origin servers, in accordance with some embodiments.

FIG. 12 is a flow diagram of a method 1200 for facilitating managing traffic between devices and origin servers, in accordance with some embodiments.

FIG. 13 is a flow diagram of a method 1300 for facilitating managing traffic between devices and origin servers, in accordance with some embodiments.

FIG. 14 is a flow diagram of a method 1400 for facilitating managing traffic between devices and origin servers, in accordance with some embodiments.

FIG. 15 is an illustration of deployment of edge servers to different autonomous systems for facilitating managing traffic between devices and origin servers, in accordance with some embodiments.

FIG. 16 is an illustration of rotation of edge servers to different autonomous systems for facilitating managing traffic between devices and origin servers, in accordance with some embodiments.

FIG. 17 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating managing traffic between devices and origin servers, in accordance with some embodiments, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for facilitating managing traffic between devices and origin servers. Further, the managing of the traffic between the devices and the origin servers may include mitigating Border Gateway Protocol (BGP) hijacking attacks using distributed edge servers.

Further, the present disclosure relates to network security and, more specifically, to methods and systems for preventing and mitigating Border Gateway Protocol (BGP) hijacking attacks using distributed edge servers in multiple autonomous systems (AS).

Further, the present disclosure describes, an approach to mitigate border gateway protocol BGP hijacking attacks by utilizing a distributed network of edge servers located in multiple autonomous systems (AS). These edge servers act as intermediaries between clients and the origin server, ensuring that client traffic is always directed to the origin server through secure and reliable pathways. This approach effectively isolates clients from the effects of BGP hijacking, as they never connect directly to the origin server's IP address.

Further, the present disclosure describes edge servers deployed in various cloud providers, each with its own AS. The edge servers are configured to dynamically route traffic to the origin server, even in the event of a BGP hijack attack. This is achieved by using techniques such as Domain Name System (DNS) resolution, secure tunnels, and subnet management. The invention also includes mechanisms for continuously rotating the locations of edge servers to further enhance security.

Further, the present disclosure describes system architecture. The system consists of the following components:
Origin Server: The primary server that hosts the services or data intended for client access.
Edge Servers: Distributed servers located in multiple autonomous systems (AS) that act as intermediaries between clients and the origin server.
Clients: End-users or devices that access services hosted on the origin server.
Domain Name System (DNS) Resolver: A system that directs client traffic to the appropriate edge server IP address.

Further, the present disclosure describes a strategical deployment of edge servers in multiple ASs, typically using various cloud service providers. Each cloud provider is assumed to have at least one AS, and many have several. By deploying edge servers in diverse ASs, the system ensures that a successful BGP hijack attack would require hijacking all relevant ASs, which is highly unlikely.

Further, the present disclosure describes a connection process. Further, the process comprises:
DNS Resolution: When a client attempts to connect to the origin server, the DNS resolver provides the IP address of an edge server instead of the origin server's IP address.
Connection to Edge Server: The client establishes a connection with the edge server.
Traffic Forwarding: The edge server forwards the client's traffic to the origin server through secure channels.

Further, the present disclosure describes strategies for mitigation of BGP hijacking. Further, the strategies comprise:
Detection: The edge servers monitor for signs of BGP hijacking.
Alternate Routing: Edge servers can connect to the origin server through pre-established secure tunnels (e.g., virtual private network (VPN), generic routing encapsulation (GRE), etc.).
Subnets Management: The origin server can activate an unnamed subnet known only to edge servers, allowing them to connect using alternative pathways.
Dynamic Reconfiguration: Edge servers can be moved to different ASs, making it difficult for attackers to maintain control over hijacked routes.

Further, the present disclosure describes that during normal operations, clients connect to the origin server via edge servers, ensuring high availability and security. Further, upon detection of a BGP hijack attack, the edge servers switch to using secure tunnels to reach the origin server, maintaining the integrity and confidentiality of client data. Further, the edge servers are dynamically rotated across different ASs, preventing attackers from predicting and hijacking all necessary routes.

Further, the present disclosure describes a method for mitigating BGP hijacking attacks. Further, the method comprises deploying multiple edge servers in diverse autonomous systems (AS). Further, the method comprises directing client traffic to said edge servers via DNS resolution. Further, the method comprises forwarding client traffic from said edge servers to an origin server. Further, the method comprises detecting BGP hijacking attacks and responding by rerouting traffic through secure tunnels. Further, the method includes a step, wherein said edge servers are deployed in cloud providers, each having at least one AS. Further, the method further comprising rotating the deployment of edge servers to different ASs to enhance security. Further, the method includes a step, wherein the origin server activates an unnamed subnet for edge servers to connect during a BGP hijack attack.

Further, the present disclosure further describes a system for mitigating BGP hijacking attacks, comprising an origin server, a plurality of edge servers deployed in multiple autonomous systems (AS), a DNS resolver configured to direct client traffic to said edge servers, Secure tunnels between said edge servers and the origin server for forwarding client traffic. Further, the system further comprises detection mechanisms for identifying BGP hijacking attacks. Further, the system is described, wherein said secure tunnels include VPN and GRE tunnels. Further, the system is described, wherein said edge servers are dynamically reconfigured to different ASs to prevent successful hijacking.

Further, the present disclosure describes a method and system for mitigating BGP hijacking attacks by using a distributed network of edge servers located in multiple autonomous systems (AS). The edge servers act as intermediaries between clients and the origin server, ensuring secure and reliable traffic routing even in the event of a BGP hijack attack. The system includes mechanisms for dynamic reconfiguration of edge servers, secure tunneling, and alternative subnet management to maintain service integrity and confidentiality.

Further, the present disclosure describes that In a typical deployment, an organization deploys edge servers across multiple cloud providers such as AWS™, Google™ Cloud, and Azure™. Each of these cloud providers operates multiple autonomous systems (AS). When a client attempts to access the organization's services, the DNS resolver directs the client to one of the edge servers based on factors such as load balancing and geographical proximity. Further, the edge server then establishes a secure connection to the origin server using either a VPN or GRE tunnel. This ensures that even if the origin server's IP address is hijacked, the client traffic remains unaffected since it is routed through the secure edge server network.

Further, the present disclosure describes that To enhance security, the edge servers are periodically moved to different ASs. This can be achieved by terminating existing edge server instances and launching new ones in different ASs within the same or different cloud providers. This rotation makes it extremely challenging for an attacker to successfully hijack all relevant ASs simultaneously. For instance, the edge servers initially deployed in AWS™'s AS might be reconfigured to operate in Google™ Cloud's AS after a predefined period or in response to detected threats. This dynamic reconfiguration is managed by an automated system that monitors network conditions and potential security threats.

Further, the present disclosure describes that during a detected BGP hijack attack, the origin server can activate an unnamed subnet known only to the edge servers. This subnet remains unpublished under normal conditions to prevent it from being hijacked. The edge servers are pre-configured to attempt connections to this unnamed subnet when an attack is detected. This ensures a secure pathway for client traffic to reach the origin server, bypassing the hijacked routes. For example, if the origin server's primary subnet is under attack, the edge servers will switch their connections to the unnamed subnet, which is dynamically advertised to them. The origin server maintains control over this subnet, ensuring it can reestablish secure communication with the edge servers.

Further, the present disclosure provides resilience to BGP hijacking by using multiple ASs and rotating edge server deployments, the system significantly reduces the likelihood of a successful BGP hijacking attack. Further, the present disclosure provides secure tunnels and unnamed subnets to ensure that client traffic remains confidential and reaches the intended origin server. Further, the system can easily scale by adding more edge servers across different ASs as the demand grows. Further, the disclosed system provides dynamic reconfiguration of edge servers and allows for adaptive responses to changing network conditions and security threats.

Further, the present disclosure describes edge server configuration, wherein the edge servers should be configured with robust security measures, including firewalls and intrusion detection systems, to prevent unauthorized access. Further, the present disclosure provides monitoring and detection which includes continuous monitoring of network traffic is essential to promptly detect BGP hijacking attempts and trigger appropriate responses. Further, the present disclosure describes the deployment of edge servers across multiple cloud providers requires coordination to ensure that each provider's AS is properly utilized and managed. Further, the present disclosure describes providing careful consideration should be given to the geographical distribution of edge servers to minimize latency and maximize performance for end-users for latency and performance.

Further, the present disclosure describes that each edge server is configured with the following components and capabilities:
Firewall: Protects the server from unauthorized access and malicious traffic.
Intrusion Detection System (IDS): Monitors network traffic for suspicious activities and alerts administrators of potential security breaches.
Load Balancer: Distributes incoming client traffic evenly across available resources to optimize performance and prevent overloading any single server.
Secure Tunnels: Establishes secure communication channels, such as VPN or GRE tunnels, to the origin server.
Traffic Monitoring: Continuously monitors traffic patterns to detect anomalies indicative of BGP hijacking attempts.

Further, the present disclosure describes the role of the DNS resolver in directing client traffic to the appropriate edge server. It operates based on the principles such as:
Geographical Proximity: Selects edge servers closest to the client to minimize latency.
Load Balancing: Distributes client connections across multiple edge servers to ensure even load distribution and high availability.
Dynamic Updates: Continuously updates the DNS records to reflect the current IP addresses of the edge servers, adapting to network changes and potential threats.

Further, the present disclosure describes detection and response mechanisms to effectively mitigate BGP hijacking attacks, the system incorporates robust detection and response mechanisms:
Traffic Anomalies: The system analyzes traffic patterns for deviations from the norm, such as sudden spikes in latency or changes in routing paths, which may indicate a BGP hijack.
Predefined Rules: A set of rules is established to identify potential hijacking attempts based on known attack signatures and behaviors.
Automated Response: Upon detecting a potential hijack, the system automatically reroutes traffic through secure tunnels or activates unnamed subnets to maintain service continuity.

Further, the present disclosure describes exemplary implementations. Further, the exemplary implementations comprise:
Enterprise network: An enterprise deploys edge servers across multiple cloud providers to protect its internal network from BGP hijacking. Employees and partners connect to the enterprise applications through these edge servers, ensuring secure and reliable access. The DNS resolver dynamically directs traffic to the most appropriate edge server based on current network conditions and load.
Content delivery network (CDN): A CDN provider uses the described system to enhance the security of its content delivery services. Edge servers are strategically placed in various ASs, ensuring that clients accessing the CDN's content are shielded from BGP hijacking attacks. The provider's DNS resolver adapts in real-time to changing network conditions, directing clients to the optimal edge server.
E-commerce platform: An e-commerce platform leverages the system to protect its online storefront from BGP hijacking. Customers accessing the platform are directed to edge servers that forward their requests to the origin servers through secure tunnels. This setup not only ensures high availability but also secures sensitive customer data from potential interception.

Further, the present disclosure describes the integration the system with Software-Defined Wide Area Network (SD-WAN) technologies can further enhance traffic management and security. Further, the present disclosure describes utilizing artificial intelligence (AI) and machine learning (ML) to improve the detection of BGP hijacking attempts by identifying more sophisticated patterns and anomalies. Further, the present disclosure describes employing blockchain technology for verifying and securing routing information to add an additional layer of trust and integrity.

Further, the present disclosure describes a method for mitigating Border Gateway Protocol (BGP) hijacking attacks, in accordance with some embodiments, comprising Deploying a distributed network of edge servers across multiple autonomous systems (ASs). Further, the method may include configuring said edge servers to act as packet forwarders, routers, and proxies. Further, the method may include directing client connections to said edge servers instead of an origin server's IP address. Further, the method may include establishing secure tunnels between said edge servers and said origin server. Further, the method may include utilizing blockchain verification to ensure the integrity of routing paths. Further, the method may include implementing AI-based anomaly detection to analyze network traffic patterns and detect hijacking attempts. Further, the method may include dynamically reconfiguring said edge servers in response to detected threats. Further, described the method, wherein said secure tunnels are selected from the group consisting of VPN, GRE, and Internet Protocol Security (IPsec) tunnels. Further, the method comprises deploying said edge servers across multiple cloud providers to enhance redundancy and minimize latency. Further, described the method, wherein said blockchain verification involves maintaining a blockchain ledger at each edge server to record and verify routing information.

Further, the present disclosure describes a system for mitigating BGP hijacking attacks, in accordance with some embodiments. Further, the system comprises a plurality of edge servers deployed across multiple autonomous systems (ASs). Further, the system comprises secure tunnels established between said edge servers and an origin server. Further, the system comprises blockchain verification mechanisms to ensure the integrity of routing paths. Further, the system comprises AI-based anomaly detection algorithms to analyze network traffic patterns. Further, the system comprises dynamic reconfiguration capabilities to adjust the deployment of said edge servers in response to detected threats. Further, disclosed the system, wherein said edge servers are configured to act as packet forwarders, routers, and proxies. Further, disclosed the system, wherein said secure tunnels are selected from the group consisting of VPN, GRE, and IPsec tunnels. Further, the system comprises real-time analytics and reporting tools to monitor network performance and security. Further, the system comprises advanced encryption techniques, including quantum-resistant algorithms and end-to-end encryption. Further, disclosed the system, wherein said dynamic reconfiguration involves automated deployment and removal of edge servers based on real-time network conditions.

Further, the present disclosure describes a method and system for mitigating Border Gateway Protocol (BGP) hijacking attacks through the deployment of a distributed network of edge servers across multiple autonomous systems. These edge servers act as packet forwarders, routers, and proxies, ensuring that client connections are directed to secure edge servers rather than the origin server's IP address. The system employs secure tunneling protocols, blockchain verification, AI-based anomaly detection, and dynamic reconfiguration to maintain the integrity, availability, and confidentiality of network traffic. The invention provides a robust, scalable, and cost-efficient solution to enhance network security against sophisticated cyber threats.

Further, the described method and system provide a robust solution to the problem of BGP hijacking by leveraging a distributed network of edge servers. Through dynamic reconfiguration, secure tunneling, and advanced detection mechanisms, the invention ensures the integrity and confidentiality of internet traffic, making it a vital tool for organizations seeking to protect their network infrastructure from sophisticated cyber threats.

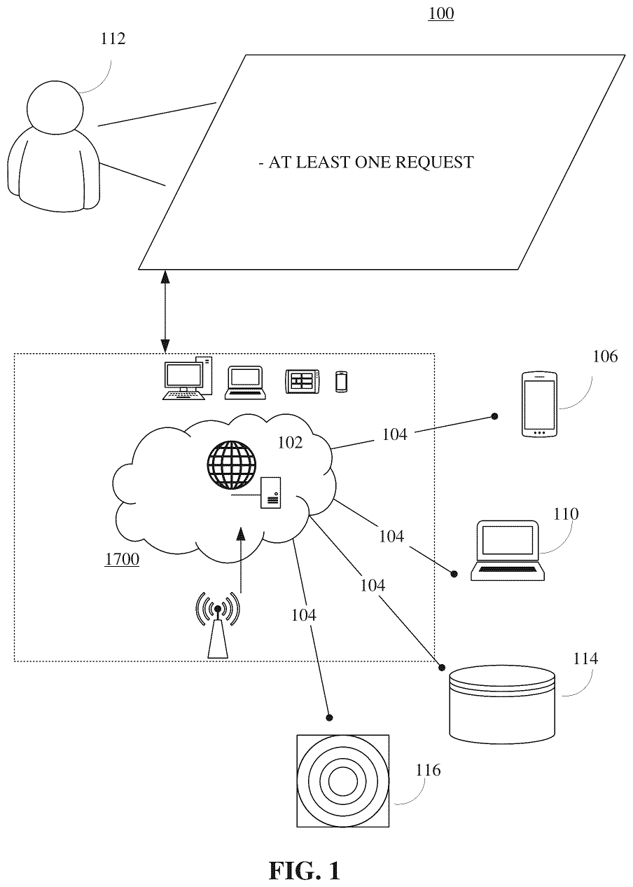

FIG. 1 is an illustration of an online platform 100 consistent with various embodiments of the present disclosure. By way of non-limiting example, the online platform 100 to facilitate managing traffic between devices and origin servers, in accordance with some embodiments. may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1700.

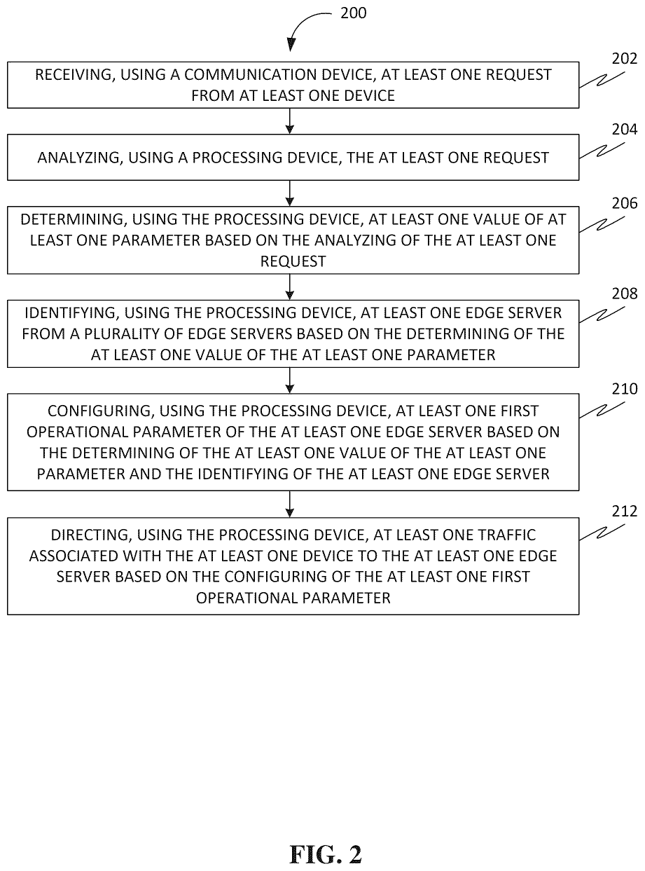

FIG. 2 is a flowchart of a method 200 for facilitating managing traffic between devices and origin servers, in accordance with some embodiments. Accordingly, at 202 the method 200 may include receiving, using a communication device, at least one request from at least one device. Further, the at least one request may include, for example, a request for visiting a link, a request for visiting a webpage, a request for accessing a content, a request for accessing a service, etc. Further, the at least one device may include a mobile, a laptop, a computer, a tablet, etc. Further, the at least one device may include a computing device, a client device, etc.

Further, at 204 the method 200 may include analyzing, using a processing device, the at least one request.

Further, at 206 the method 200 may include determining, using the processing device, at least one value of at least one parameter based on the analyzing of the at least one request. Further, the at least one parameter may include, for example, a location, a distance from a location, a network type, an internet protocol (IP) address, a domain name, a geographical proximity, a load, a route, etc. Further, the at least one value may include a quantitative value associated with the distance, a landmark of the location, the geographical proximity, the load, the route, etc. Further, the at least one value may include a destination IP address, a particular domain name, etc.

Further, at 208 the method 200 may include identifying, using the processing device, at least one edge server from a plurality of edge servers based on the determining of the at least one value of the at least one parameter. Further, the at least one edge server may be comprised in a remote computing device, a remote server, etc. Further, the plurality of edge servers may be deployed in a plurality of cloud platforms associated with a plurality of cloud providers. Further, the plurality of cloud platforms may be associated with a plurality of autonomous systems. Further, the plurality of cloud platforms may be associated with a plurality of cloud servers.

Further, at 210 the method 200 may include configuring, using the processing device, at least one first operational parameter of the at least one edge server based on the determining of the at least one value of the at least one parameter and the identifying of the at least one edge server. Further, the at least one first operational parameter may be associated with a traffic handling of the at least one edge server. Further, at least one first operational parameter may include a parameter associated with packet forwarding, routing, proxy, etc.

Further, at 212 the method 200 may include directing, using the processing device, at least one traffic associated with the at least one device to the at least one edge server based on the configuring of the at least one first operational parameter. Further, the directing may include routing, forwarding, etc., of the at least one traffic. Further, the at least one edge server may be configured for handling the at least one traffic between the at least one device and at least one origin server based on the configuring of the at least one first operational parameter and the directing of the at least one traffic. Further, the at least one traffic may include data packets, etc. Further, the at least one traffic may include a network traffic, a data traffic, an Internet traffic, etc. Further, the at least one traffic may include a flow of data between the at least one device and the at least one origin server. Further, the at least one origin server may include a server associated with an organization, an entity, an individual, etc.

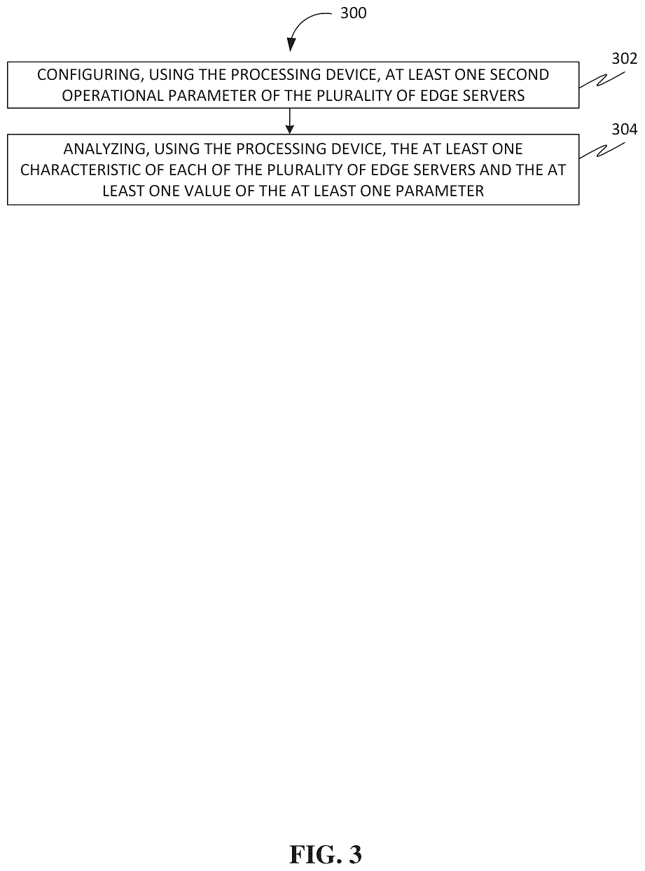

FIG. 3 is a flowchart of a method 300 for facilitating managing traffic between devices and origin servers, in accordance with some embodiments. Accordingly, at 302 the method 300 may include configuring, using the processing device, at least one second operational parameter of the plurality of edge servers. Further, the at least one second operational parameter may be associated with a deployment of the plurality of edge servers. Further, at least one of the plurality of edge servers may be configured for operating in a plurality of autonomous systems based on the configuring of the at least one second operational parameter of the plurality of edge servers. Further, each of the plurality of edge servers may be associated with at least one characteristic based on the operating of the plurality of edge servers in the plurality of autonomous systems. Further, the at least one second operational parameter may include networking requirements, server specifications, timelines, schedules, server location, etc. Further, the plurality of autonomous systems may include a group of devices in a single routing policy. Further, the at least one characteristic may include a geolocation, a space size, a traffic handling capacity, a processing capacity, etc.

Further, at 304 the method 300 may include analyzing, using the processing device, the at least one characteristic of each of the plurality of edge servers and the at least one value of the at least one parameter. Further, the identifying of the at least one edge server from the plurality of edge servers may be further based on the analyzing of the at least one characteristic of each of the plurality of edge servers and the at least one value of the at least one parameter.

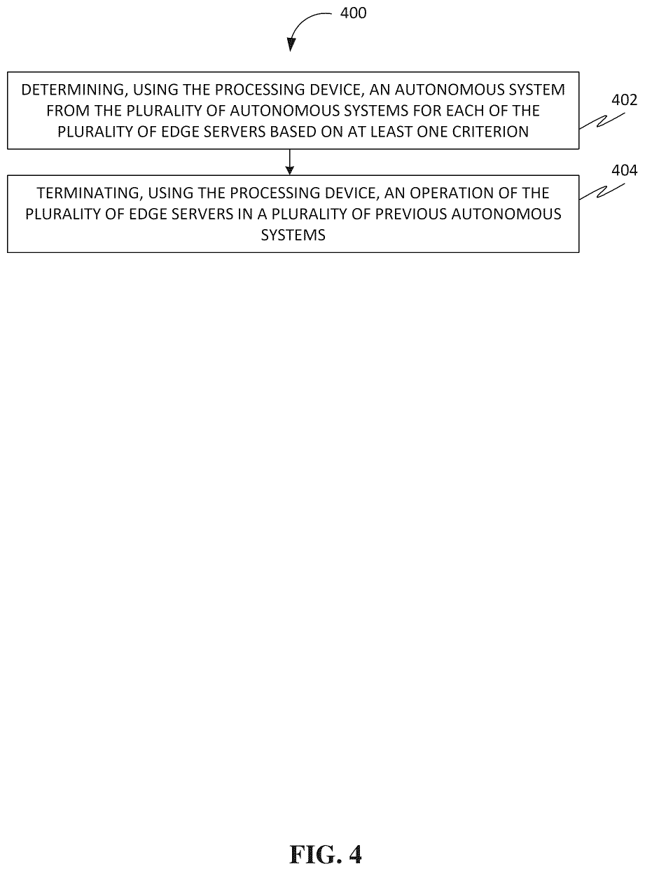

FIG. 4 is a flowchart of a method 400 for facilitating managing traffic between devices and origin servers, in accordance with some embodiments. Accordingly, at 402 the method 400 may include determining, using the processing device, an autonomous system from the plurality of autonomous systems for each of the plurality of edge servers based on at least one criterion. Further, the autonomous system may include a group of devices in a single routing policy, for example, a remote desktop protocol from a single IP. Further, at least one of the at least one origin server may be comprised in the autonomous system. Further, the at least one criterion may include an elapsing of at least one time period, an instance of at least one attack, etc.

Further, at 404 the method 400 may include terminating, using the processing device, an operation of the plurality of edge servers in a plurality of previous autonomous systems. Further, the configuring of the at least one second operational parameter of the plurality of edge servers may be further based on the determining of the autonomous system from the plurality of autonomous systems for each of the plurality of edge servers and the terminating of the operation of the plurality of the edge servers in the plurality of previous autonomous systems. Further, the plurality of previous autonomous systems may include a group of devices in a single routing policy, for example, a remote desktop protocol from a single IP that may be used for the deployment of the plurality of edge servers. Further, the terminating and the deployment of the plurality of edge servers allows for a rotation of the plurality of the edge servers in the plurality of autonomous systems and the plurality of previous autonomous systems.

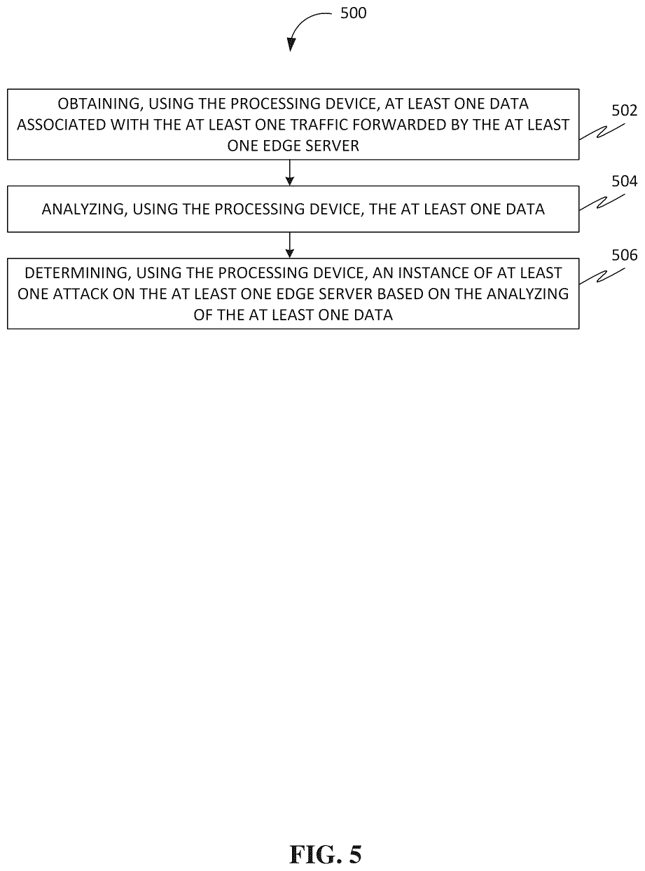

FIG. 5 is a flowchart of a method 500 for facilitating managing traffic between devices and origin servers, in accordance with some embodiments. Accordingly, at 502 the method 500 may include obtaining, using the processing device, at least one data associated with the at least one traffic forwarded by the at least one edge server. Further, the at least one data may include a domain name resolution, an IP address, etc. Further, the at least one data characterizes the at least one traffic. Further, the at least one data comprises a destination and an origin of the at least one traffic, a volume of the at least one traffic, a route of the at least one traffic, etc.

Further, at 504 the method 500 may include analyzing, using the processing device, the at least one data.

Further, at 506 the method 500 may include determining, using the processing device, an instance of at least one attack on the at least one edge server based on the analyzing of the at least one data. Further, the at least one attack may include a BGP hijacking attack. Further, the configuring of the at least one second operational parameter of the plurality of edge servers may be further based on the determining of the instance of the at least one attack. Further, the at least one attack may include changing the receiver IP, rerouting the at least one traffic, etc.

Further, in an embodiment, the analyzing of the at least one data may include analyzing the at least one data using at least one machine learning model. Further, the at least one machine learning model may be trained for detecting at least one of a pattern, a correlation, and an anomaly in the at least one data. Further, at least one of the pattern, the correlation, and the anomaly may be indicative of the at least one attack. Further, the determining of the instance of the at least one attack may be further based on the detecting. Further, the at least one machine learning model may include a convolutional neural network, a recurrent neural network, etc. Further, the pattern may include a repetition of IP. Further, the correlation may include a likeness in the IP, an anomaly may include a change in a network route, a change in the receiver IP, etc. Further, the at least one machine learning model may be trained in a dataset comprising at least one of a signature and a behavior of the at least one attack. Further, at least one of the signature and the behavior corresponds to the at least one of the pattern, the correlation, and the anomaly.

Further, in an embodiment, the configuring of the at least one first operational parameter of the at least one edge server may be further based on the determining of the instance of the at least one attack. Further, the configuring of the at least one first operational parameter may include connecting with the at least one origin server using at least one unnamed subnet of the at least one origin server. Further, the at least one unnamed subnet may be dynamically advertised to the at least one edge server.

Further, in an embodiment, the at least one edge server may be further configured for establishing at least one secure tunnel to the at least one origin server based on the configuring of the at least one first operational parameter. Further, the handling of the at least one traffic between the at least one origin server and the at least one device may be through the at least one secure tunnel based on the establishing of the at least one secure tunnel. Further, the at least one secure tunnel may include a secure network route, a secure network connection, a virtual private network tunnel, a generic routing encapsulation tunnel, etc.

Further, in an embodiment, the at least one edge server may be further configured for establishing at least one connection to the at least one origin server using at least one subnet of the at least one origin server based on the configuring of the at least one first operational parameter. Further, the handling of the at least one traffic between the at least one origin server and the at least one device may be through the at least one connection based on the establishing of the at least one connection. Further, the at least one connection may include an establishment of a network route, an establishment of a network tunnel, etc.

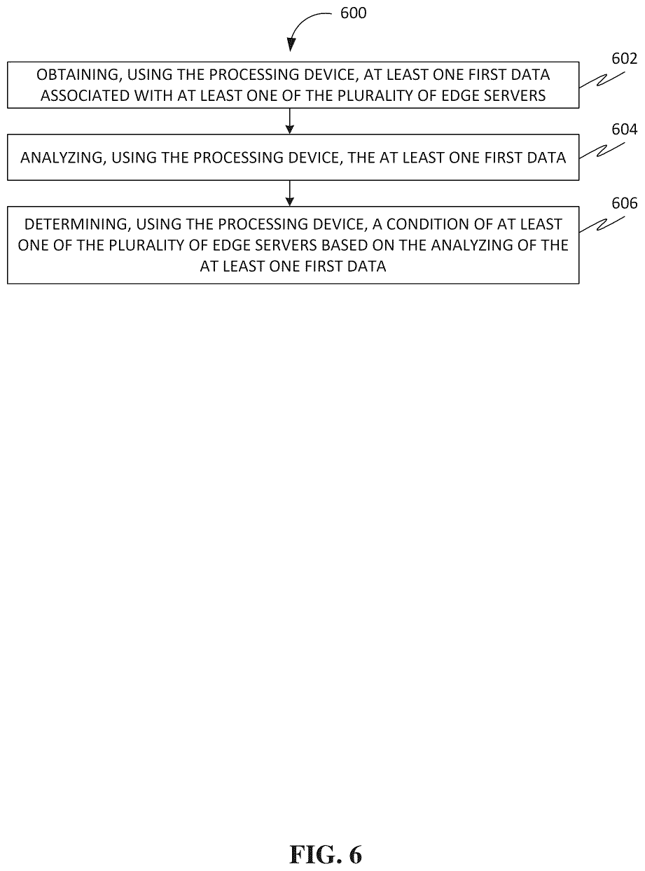

FIG. 6 is a flowchart of a method 600 for facilitating managing traffic between devices and origin servers, in accordance with some embodiments. Accordingly, at 602 the method 600 may include obtaining, using the processing device, at least one first data associated with at least one of the plurality of edge servers. Further, the at least one first data may include a routing policy associated with the plurality of edge servers, a network route associated with the plurality of edge servers, etc.

Further, at 604 the method 600 may include analyzing, using the processing device, the at least one first data.

Further, at 604 the method 600 may include determining, using the processing device, a condition of at least one of the plurality of edge servers based on the analyzing of the at least one first data. Further, the configuring of the at least one second operational parameter of the plurality of edge servers may be further based on the determining of the condition of at least one of the plurality of edge servers. Further, the condition may include a load, a network condition, etc., on at least one of the plurality of edger servers.

Further, in some embodiments, the at least one edge server may be configured for accessing at least one distributed ledger of at least one blockchain based on the configuring of the at least one first operational parameter. Further, the at least one distributed ledger may include a blockchain ledger. Further, the at least one edge server may be configured for obtaining at least one routing information associated with the at least one edge server based on the accessing. Further, the at least one routing information may include IP addresses, IP subnets, etc. Further, the at least one edge server may be configured for analyzing the at least one routing information and the at least one traffic. Further, the at least one edge server may be configured for generating at least one decision associated with the handling of the traffic handling based on the analyzing of the at least one routing information and the at least one traffic. Further, the handling of the at least one traffic may be further based on the at least one decision. Further, the at least one edge server may be configured for storing the at least one decision in the at least one distributed ledger. Further, the at least one distributed ledger may include a synchronized database duplicated and shared with all the systems of the database. Further, the at least one blockchain may include a decentralized peer-to-peer database architecture with built-in encryption.

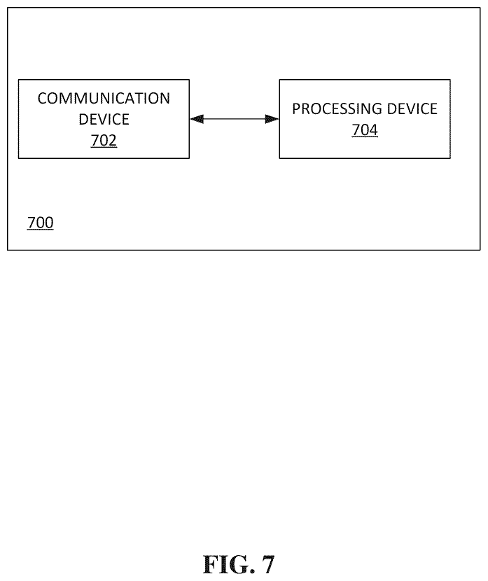

FIG. 7 is a block diagram of a system 700 for facilitating managing traffic between devices and origin servers, in accordance with some embodiments. Accordingly, the system 700 may include a communication device 702 and a processing device 704.

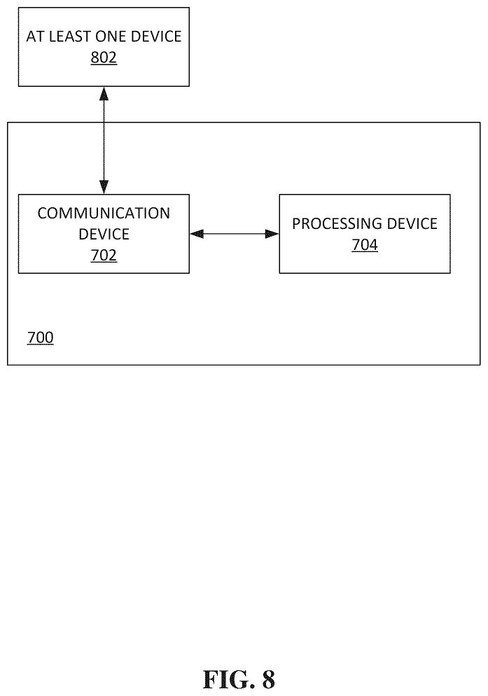

Further, the communication device 702 may be configured for receiving at least one request from at least one device 802, as shown in FIG. 8. Further, the at least one request may include, for example, visiting a link, visiting a webpage, etc. Further, the at least one device 802 may include a mobile, a laptop, a computer, a tablet, etc. Further, the at least one device 802 may include a client device, a computing device, etc.

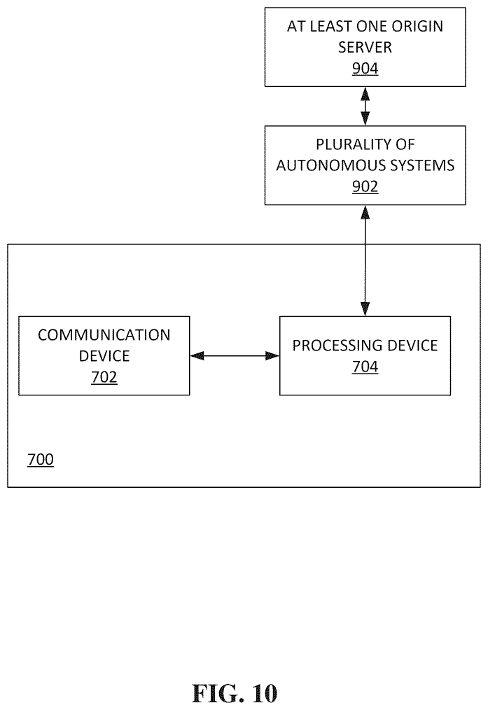

Further, the processing device 704 may be communicatively coupled with the communication device 702. Further, the processing device 704 may be configured for analyzing the at least one request. Further, the processing device 704 may be configured for determining at least one value of at least one parameter based on the analyzing of the at least one request. Further, the at least one parameter may include, for example, a location, a distance from a location, a network type, an internet protocol (IP), etc. Further, the at least one value may include a mathematical value associated with the distance, a landmark of the location, an IP address, etc. Further, the processing device 704 may be configured for identifying at least one edge server from a plurality of edge servers based on the determining of the at least one value of the at least one parameter. Further, the at least one edge server may include a remote desktop, a server, etc. Further, the processing device 704 may be configured for configuring at least one first operational parameter of the at least one edge server based on the determining of the at least one value of the at least one parameter and the identifying of the at least one edge server. Further, the at least one first operational parameter may be associated with a traffic handling of the at least one edge server. Further, at least one first operational parameter may include a use of the at least one edge server, for example, packet forwarding, routing, proxy, etc. Further, the processing device 704 may be configured for directing at least one traffic associated with the at least one device 802 to the at least one edge server based on the configuring of the at least one first operational parameter. Further, the at least one edge server may be configured for handling the at least one traffic between the at least one device 802 and at least one origin server 904, as shown in FIG. 10, based on the configuring of the at least one first operational parameter and the directing of the at least one traffic. Further, the at least one traffic may include a flow of data between the at least one device 802 and the at least one origin server 904. Further, the at least one origin server 904 may include a server associated with an organization, entity, businesses, etc.

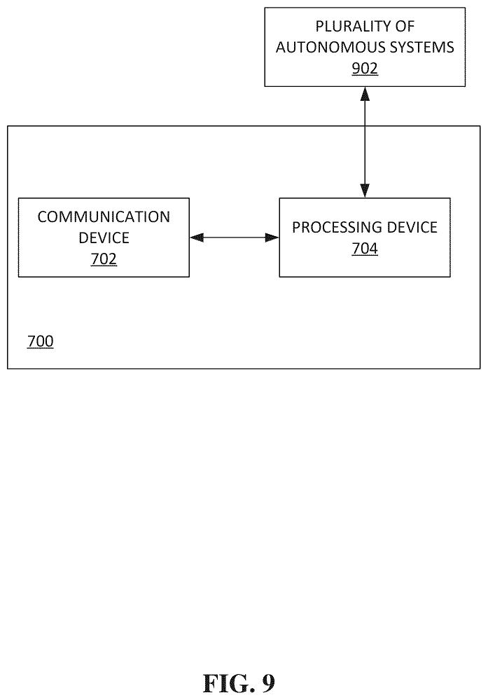

Further, in some embodiments, the processing device 704 may be further configured for configuring at least one second operational parameter of the plurality of edge servers. Further, the at least one second operational parameter may be associated with a deployment of the plurality of edge servers. Further, at least one of the plurality of edge servers may be configured for operating in a plurality of autonomous systems 902, as shown in FIG. 9, based on the configuring of the at least one second operational parameter of the plurality of edge servers. Further, each of the plurality of edge servers may be associated with at least one characteristic based on the operating of the plurality of edge servers in the plurality of autonomous systems 902. Further, the processing device 704 may be further configured for analyzing the at least one characteristic of each of the plurality of edge servers and the at least one value of the at least one parameter. Further, the at least one second operational parameter may include networking requirements, server specifications, timelines, and schedules, etc. Further, the plurality of autonomous systems 902 may include a group of devices in a single routing policy. Further, the at least one characteristic may include a speed of traffic, a geolocation, a space size, etc. Further, the identifying of the at least one edge server from the plurality of edge servers may be further based on the analyzing of the at least one characteristic of each of the plurality of edge servers and the at least one value of the at least one parameter.

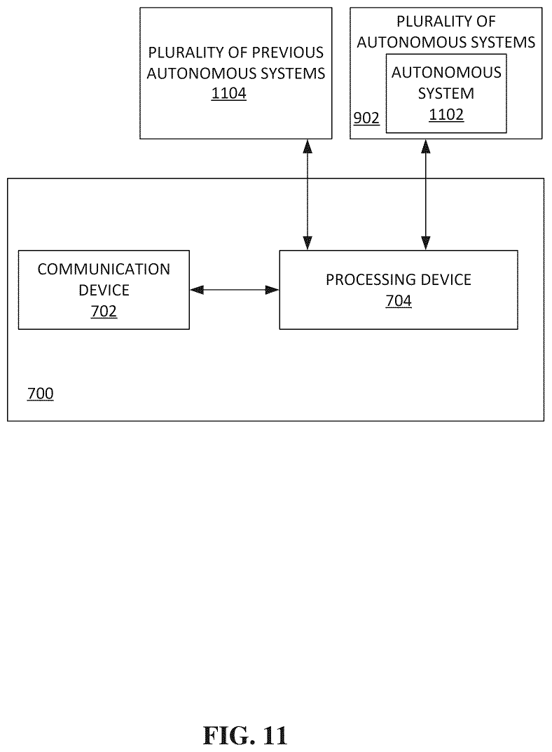

Further, in an embodiment, the processing device 704 may be further configured for determining an autonomous system 1102, as shown in FIG. 11, from the plurality of autonomous systems 902 for each of the plurality of edge servers based on at least one criterion. Further, the autonomous system 1102 may include a group of devices in a single routing policy, for example, a remote desktop protocol from a single IP. Further, the processing device 704 may be further configured for terminating an operation of the plurality of edge servers in a plurality of previous autonomous systems 1104, as shown in FIG. 11. Further, the configuring of the at least one second operational parameter of the plurality of edge servers may be further based on the determining of the autonomous system 1102 from the plurality of autonomous systems 902 for each of the plurality of edge servers and the terminating of the operation of the plurality of the edge servers in the plurality of previous autonomous systems 1104. Further, the plurality of previous autonomous systems 1104 may include a group of devices in a single routing policy, for example, a remote desktop protocol from a single IP that may be used for deployment of the plurality of edge servers. Further, in an embodiment, the processing device 704 may be further configured for obtaining at least one data associated with the at least one traffic forwarded by the at least one edge server. Further, the at least one data may include a domain name resolution, an IP address, etc. Further, the processing device 704 may be further configured for analyzing the at least one data. Further, the processing device 704 may be further configured for determining an instance of at least one attack on the at least one edge server based on the analyzing of the at least one data. Further, the configuring of the at least one second operational parameter of the plurality of edge servers may be further based on the determining of the instance of the at least one attack. Further, the at least one attack may include changing the receiver IP, rerouting the at least one traffic, etc.

Further, in an embodiment, the analyzing of the at least one data may include analyzing the at least one data using at least one machine learning model. Further, the at least one machine learning model may be trained for detecting at least one of a pattern, a correlation, and an anomaly in the at least one data. Further, at least one of the pattern, the correlation, and the anomaly may be indicative of the at least one attack. Further, the determining of the instance of the at least one attack may be further based on the detecting. Further, the at least one machine learning model may include a convolutional neural network, a recurrent neural network, etc. Further, the pattern may include a repetition of IP. Further, the correlation may include a likeness in the IP, an anomaly may include a change in a network route, change in the receiver IP.

Further, in an embodiment, the configuring of the at least one first operational parameter of the at least one edge server may be further based on the determining of the instance of the at least one attack.

Further, in an embodiment, the at least one edge server may be further configured for establishing at least one secure tunnel to the at least one origin server 904 based on the configuring of the at least one first operational parameter. Further, the handling of the at least one traffic between the at least one origin server 904 and the at least one device 802 may be through the at least one secure tunnel based on the establishing of the at least one secure tunnel. Further, the at least one secure tunnel may include a secure network route, a secure network connection, a virtual private network, a generic routing encapsulation, etc.

Further, in an embodiment, the at least one edge server may be further configured for establishing at least one connection to the at least one origin server 904 using at least one subnet of the at least one origin server 904 based on the configuring of the at least one first operational parameter. Further, the handling of the at least one traffic between the at least one origin server 904 and the at least one device 802 may be through the at least one connection based on the establishing of the at least one connection. Further, the at least one connection may include an establishment of a network route, an establishment of a network tunnel, etc.

Further, in an embodiment, the processing device 704 may be further configured for obtaining at least one first data associated with at least one of the plurality of edge servers. Further, the processing device 704 may be further configured for analyzing the at least one first data. Further, the processing device 704 may be further configured for determining a condition of at least one of the plurality of edge servers based on the analyzing of the at least one first data. Further, the configuring of the at least one second operational parameter of the plurality of edge servers may be further based on the determining of the condition of at least one of the plurality of edge servers. Further, the at least one first data may include a routing policy associated with the plurality of edge servers, a network route associated with the plurality of edge servers, etc. Further, the condition may include a secure condition, an attack condition, etc.

Further, in some embodiments, the at least one edge server may be configured for accessing at least one distributed ledger of at least one blockchain based on the configuring of the at least one first operational parameter. Further, the at least one edge server may be configured for obtaining at least one routing information associated with the at least one edge server based on the accessing. Further, the at least one edge server may be configured for analyzing the at least one routing information and the at least one traffic. Further, the at least one edge server may be configured for generating at least one decision associated with the handling of the traffic handling based on the analyzing of the at least one routing information and the at least one traffic. Further, the handling of the at least one traffic may be further based on the at least one decision. Further, the at least one edge server may be configured for storing the at least one decision in the at least one distributed ledger. Further, the at least one distributed ledger may include a synchronized database duplicated and shared to all the system of the database. Further, the at least one blockchain may include a decentralized peer-to-peer database architecture with built-in encryption.

FIG. 8 is a block diagram of the system 700 for facilitating managing traffic between devices and origin servers, in accordance with some embodiments.

FIG. 9 is a block diagram of the system 700 for facilitating managing traffic between devices and origin servers, in accordance with some embodiments.

FIG. 10 is a block diagram of the system 700 for facilitating managing traffic between devices and origin servers, in accordance with some embodiments.

FIG. 11 is a block diagram of the system 700 for facilitating managing traffic between devices and origin servers, in accordance with some embodiments.

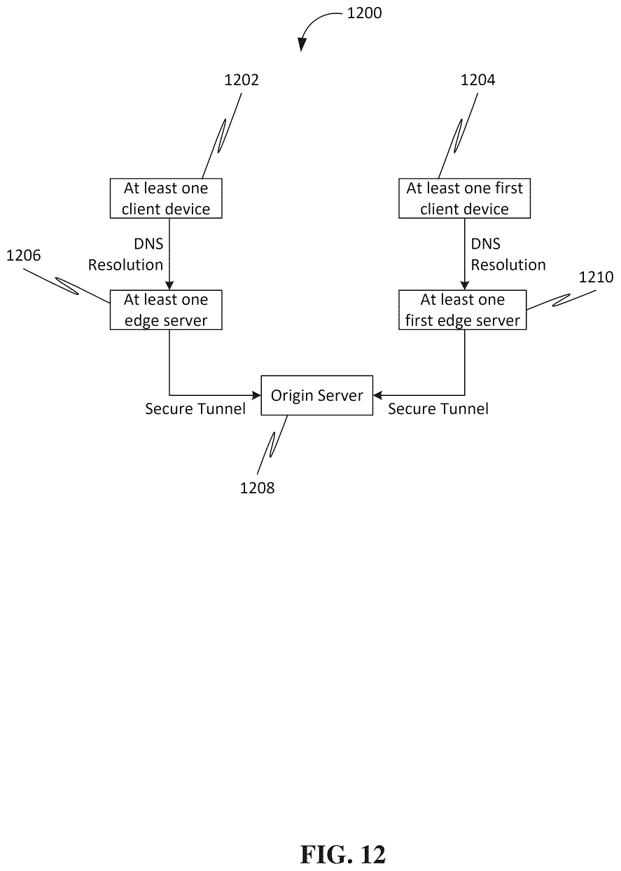

FIG. 12 is a flow diagram of a method 1200 for facilitating managing traffic between devices and origin servers, in accordance with some embodiments. Accordingly, at 1202, the method 1200 may include receiving at least one input from at least one client device.

Further, at 1206, the method 1200 may include connecting the at least one client device with at least one edge server using a domain name system (DNS) resolution.

Further, at 1208, the method 1200 may include connecting the at least one edge server with an origin server using at least one secure tunnel.

Further, at 1204, the method 1200 may include receiving at least one first input from at least one client device.

Further, at 1210, the method 1200 may include connecting the at least one client device with at least one edge server using a domain name system (DNS) resolution. Further, the method 1200 moves to 1208 after 1210.

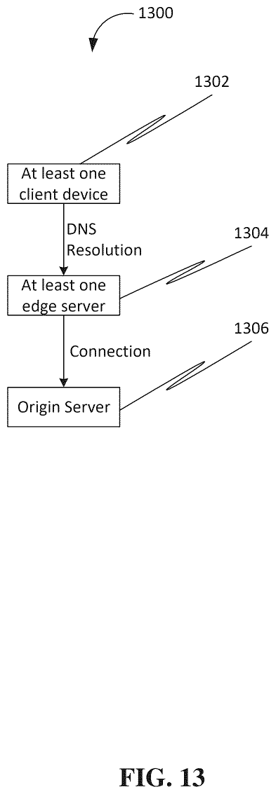

FIG. 13 is a flow diagram of a method 1300 for facilitating managing traffic between devices and origin servers, in accordance with some embodiments. Accordingly, at 1302, the method 1300 may include receiving at least one input from at least one client device.

Further, at 1304, the method 1300 may include connecting the at least one client device with at least one edge server using a domain name system (DNS) resolution.

Further, at 1306, the method 1300 may include connecting the at least one edge server with an origin server using at least one secure tunnel.

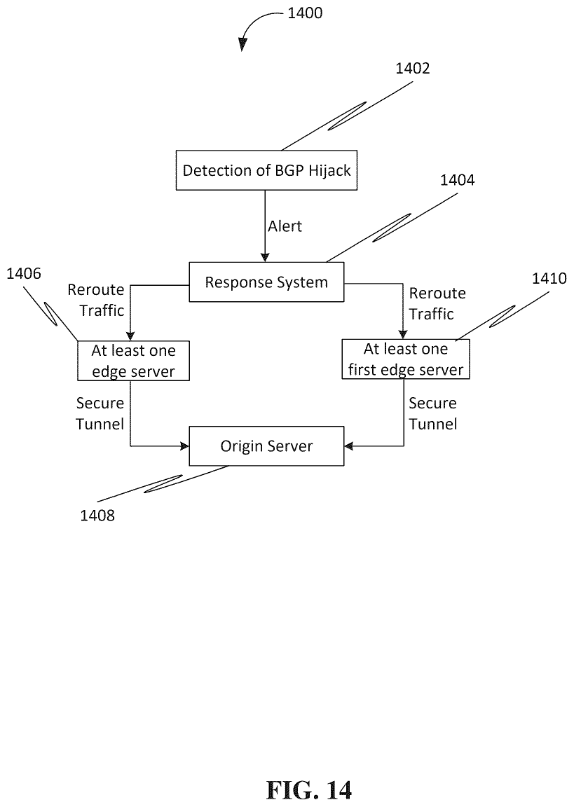

FIG. 14 is a flow diagram of a method 1400 for facilitating managing traffic between devices and origin servers, in accordance with some embodiments. Accordingly, at 1402, the method 1400 may include detecting a BGP hijack.

Further, at 1404, the method 1400 may include sending an alert to a response system.

Further, at 1406, the method 1400 may include rerouting traffic to at least one edge server.

Further, at 1408, the method 1400 may include connecting the at least one edge server to an origin server.

Further, at 1410, the method 1400 may include rerouting traffic to at least one edge server. Further, the method 1400 moves to 1408.

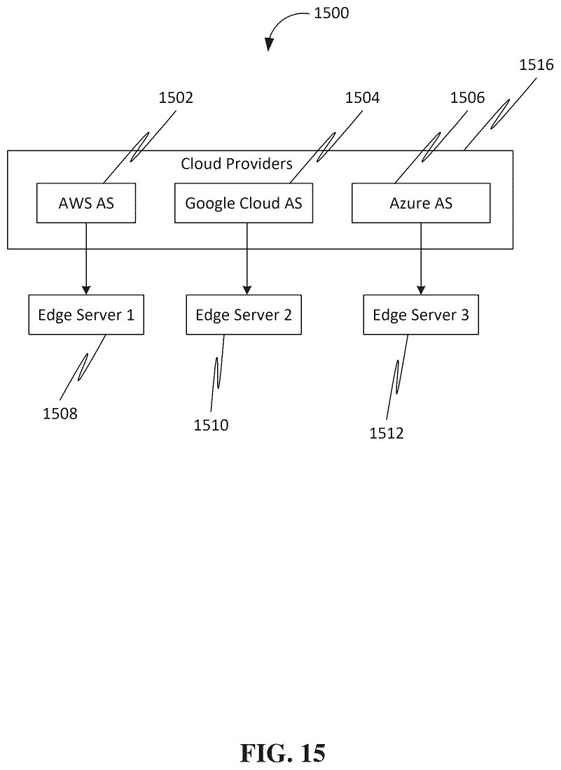

FIG. 15 is an illustration of deployment of edge servers to different autonomous systems for facilitating managing traffic between devices and origin servers, in accordance with some embodiments. Accordingly, 1502-1506 represents a plurality of autonomous systems 1516 operating on a plurality of cloud providers.

Further, 1508-1512 represents a plurality of edge servers deployed in the plurality of autonomous systems 1516.

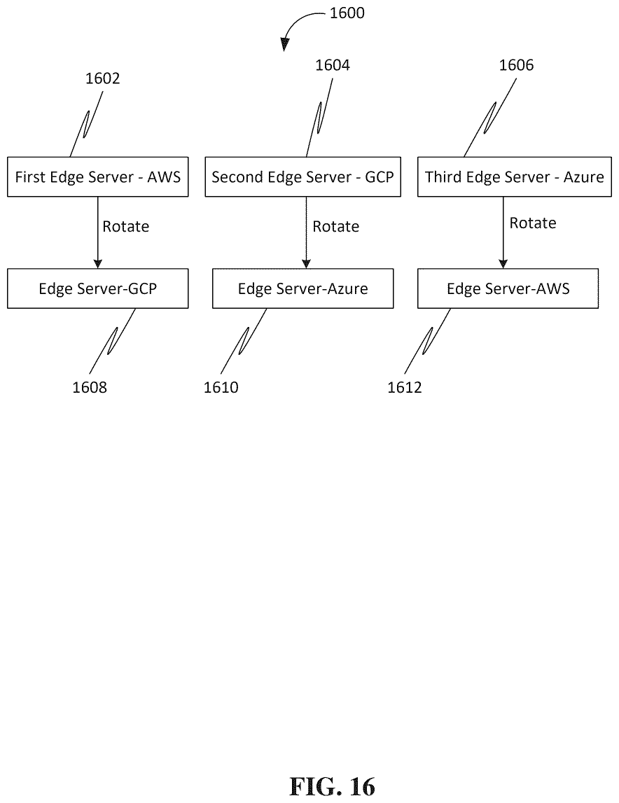

FIG. 16 is an illustration of rotation of edge servers to different autonomous systems for facilitating managing traffic between devices and origin servers, in accordance with some embodiments. Accordingly, the first edge server 1602 deployed in AWS may be rotated to edge server-GCP 1608. Further, the second edge server 1604 deployed in GCP may be rotated to edge server-azure 1610. Further, the third edge server 1606 deployed in azure may be rotated to edge server-AWS 1612.

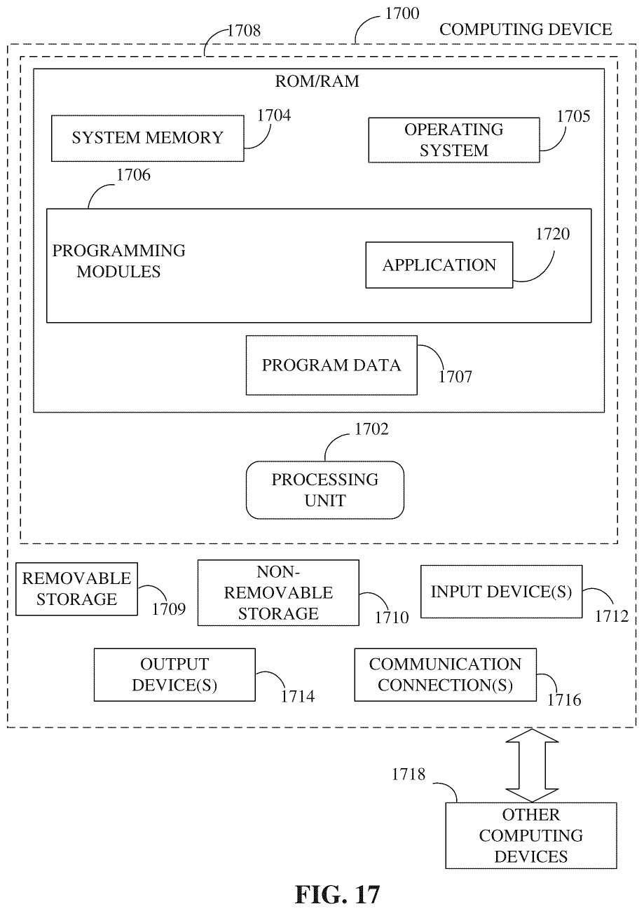

With reference to FIG. 17, a system consistent with an embodiment of the disclosure may include a computing device or cloud service, such as computing device 1700. In a basic configuration, computing device 1700 may include at least one processing unit 1702 and a system memory 1704. Depending on the configuration and type of computing device, system memory 1704 may comprise, but is not limited to, volatile (e.g. random-access memory (RAM)), non-volatile (e.g. read-only memory (ROM)), flash memory, or any combination. System memory 1704 may include operating system 1705, one or more programming modules 1706, and may include a program data 1707. Operating system 1705, for example, may be suitable for controlling computing device 1700's operation. In one embodiment, programming modules 1706 may include image-processing modules, machine learning modules, etc. Furthermore, embodiments of the disclosure may be practiced in conjunction with a graphics library, other operating systems, or any other application program and is not limited to any particular application or system. This basic configuration is illustrated in FIG. 17 by those components within a dashed line 1708.

Computing device 1700 may have additional features or functionality. For example, computing device 1700 may also include additional data storage devices (removable and/or non-removable) such as, for example, magnetic disks, optical disks, or tape. Such additional storage is illustrated in FIG. 17 by a removable storage 1709 and a non-removable storage 1710. Computer storage media may include volatile and non-volatile, removable, and non-removable media implemented in any method or technology for storage of information, such as computer-readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), other optical storage, magnetic cassettes, magnetic tape, magnetic disk storage or other magnetic storage devices, or any other medium which can be used to store information and which can be accessed by computing device 1700. Any such computer storage media may be part of device 1700. Computing device 1700 may also have input device(s) 1712 such as a keyboard, a mouse, a pen, a sound input device, a touch input device, a location sensor, a camera, a biometric sensor, etc. Output device(s) 1714 such as a display, speakers, a printer, etc. may also be included. The aforementioned devices are examples and others may be used.

Computing device 1700 may also contain a communication connection 1716 that may allow device 1700 to communicate with other computing devices 1718, such as over a network in a distributed computing environment, for example, an intranet or the Internet. Communication connection 1716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1704, including operating system 1705. While executing on processing unit 1702, programming modules 1706 (e.g., application 1720) may perform processes including, for example, one or more stages of methods, algorithms, systems, applications, servers, databases as described above. The aforementioned process is an example, and processing unit 1702 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating managing traffic between devices and origin servers, the method comprising:
receiving, using a communication device, at least one request from at least one device;
analyzing, using a processing device, the at least one request;
determining, using the processing device, at least one value of at least one parameter based on the analyzing of the at least one request;
identifying, using the processing device, at least one edge server from a plurality of edge servers based on the determining of the at least one value of the at least one parameter;
configuring, using the processing device, at least one first operational parameter of the at least one edge server based on the determining of the at least one value of the at least one parameter and the identifying of the at least one edge server, wherein the at least one first operational parameter is associated with a traffic handling of the at least one edge server; and
directing, using the processing device, at least one traffic associated with the at least one device to the at least one edge server based on the configuring of the at least one first operational parameter, wherein the at least one edge server is configured for handling the at least one traffic between the at least one device and at least one origin server based on the configuring of the at least one first operational parameter and the directing of the at least one traffic.

2. The method of claim 1 further comprising:
configuring, using the processing device, at least one second operational parameter of the plurality of edge servers, wherein the at least one second operational parameter is associated with a deployment of the plurality of edge servers, wherein at least one of the plurality of edge servers is configured for operating in a plurality of autonomous systems based on the configuring of the at least one second operational parameter of the plurality of edge servers, wherein each of the plurality of edge servers is associated with at least one characteristic based on the operating of the plurality of edge servers in the plurality of autonomous systems; and
analyzing, using the processing device, the at least one characteristic of each of the plurality of edge servers and the at least one value of the at least one parameter, wherein the identifying of the at least one edge server from the plurality of edge servers is further based on the analyzing of the at least one characteristic of each of the plurality of edge servers and the at least one value of the at least one parameter.

3. The method of claim 2 further comprising:
determining, using the processing device, an autonomous system from the plurality of autonomous systems for each of the plurality of edge servers based on at least one criterion; and
terminating, using the processing device, an operation of the plurality of edge servers in a plurality of previous autonomous systems, wherein the configuring of the at least one second operational parameter of the plurality of edge servers is further based on the determining of the autonomous system from the plurality of autonomous systems for each of the plurality of edge servers and the terminating of the operation of the plurality of the edge servers in the plurality of previous autonomous systems.

4. The method of claim 2 further comprising:
obtaining, using the processing device, at least one data associated with the at least one traffic forwarded by the at least one edge server;
analyzing, using the processing device, the at least one data; and
determining, using the processing device, an instance of at least one attack on the at least one edge server based on the analyzing of the at least one data, wherein the configuring of the at least one second operational parameter of the plurality of edge servers is further based on the determining of the instance of the at least one attack.

5. The method of claim 4, wherein the analyzing of the at least one data comprises analyzing the at least one data using at least one machine learning model, wherein the at least one machine learning model is trained for detecting at least one of a pattern, a correlation, and an anomaly in the at least one data, wherein at least one of the pattern, the correlation, and the anomaly is indicative of the at least one attack, wherein the determining of the instance of the at least one attack is further based on the detecting.

6. The method of claim 4, wherein the configuring of the at least one first operational parameter of the at least one edge server is further based on the determining of the instance of the at least one attack.

7. The method of claim 6, wherein the at least one edge server is further configured for establishing at least one secure tunnel to the at least one origin server based on the configuring of the at least one first operational parameter, wherein the handling of the at least one traffic between the at least one origin server and the at least one device is through the at least one secure tunnel based on the establishing of the at least one secure tunnel.

8. The method of claim 6, wherein the at least one edge server is further configured for establishing at least one connection to the at least one origin server using at least one subnet of the at least one origin server based on the configuring of the at least one first operational parameter, wherein the handling of the at least one traffic between the at least one origin server and the at least one device is through the at least one connection based on the establishing of the at least one connection.

9. The method of claim 2 further comprising:
obtaining, using the processing device, at least one first data associated with at least one of the plurality of edge servers;
analyzing, using the processing device, the at least one first data; and
determining, using the processing device, a condition of at least one of the plurality of edge servers based on the analyzing of the at least one first data, wherein the configuring of the at least one second operational parameter of the plurality of edge servers is further based on the determining of the condition of at least one of the plurality of edge servers.

10. The method of claim 1, wherein the at least one edge server is configured for:
accessing at least one distributed ledger of at least one blockchain based on the configuring of the at least one first operational parameter;
obtaining at least one routing information associated with the at least one edge server based on the accessing;
analyzing the at least one routing information and the at least one traffic;
generating at least one decision associated with the handling of the traffic handling based on the analyzing of the at least one routing information and the at least one traffic, wherein the handling of the at least one traffic is further based on the at least one decision; and
storing the at least one decision in the at least one distributed ledger.

11. A system for facilitating managing traffic between devices and origin servers, the system comprising:
a communication device configured for receiving at least one request from at least one device; and
a processing device communicatively coupled with the communication device, wherein the processing device is configured for:
analyzing the at least one request;
determining at least one value of at least one parameter based on the analyzing of the at least one request;
identifying at least one edge server from a plurality of edge servers based on the determining of the at least one value of the at least one parameter;
configuring at least one first operational parameter of the at least one edge server based on the determining of the at least one value of the at least one parameter and the identifying of the at least one edge server, wherein the at least one first operational parameter is associated with a traffic handling of the at least one edge server; and
directing at least one traffic associated with the at least one device to the at least one edge server based on the configuring of the at least one first operational parameter, wherein the at least one edge server is configured for handling the at least one traffic between the at least one device and at least one origin server based on the configuring of the at least one first operational parameter and the directing of the at least one traffic.

12. The system of claim 11, wherein the processing device is further configured for:
configuring at least one second operational parameter of the plurality of edge servers, wherein the at least one second operational parameter is associated with a deployment of the plurality of edge servers, wherein at least one of the plurality of edge servers is configured for operating in a plurality of autonomous systems based on the configuring of the at least one second operational parameter of the plurality of edge servers, wherein each of the plurality of edge servers is associated with at least one characteristic based on the operating of the plurality of edge servers in the plurality of autonomous systems; and
analyzing the at least one characteristic of each of the plurality of edge servers and the at least one value of the at least one parameter, wherein the identifying of the at least one edge server from the plurality of edge servers is further based on the analyzing of the at least one characteristic of each of the plurality of edge servers and the at least one value of the at least one parameter.

13. The system of claim 12, wherein the processing device is further configured for:
determining an autonomous system from the plurality of autonomous systems for each of the plurality of edge servers based on at least one criterion; and
terminating an operation of the plurality of edge servers in a plurality of previous autonomous systems, wherein the configuring of the at least one second operational parameter of the plurality of edge servers is further based on the determining of the autonomous system from the plurality of autonomous systems for each of the plurality of edge servers and the terminating of the operation of the plurality of the edge servers in the plurality of previous autonomous systems.

14. The system of claim 12, wherein the processing device is further configured for:
obtaining least one data associated with the at least one traffic forwarded by the at least one edge server;
analyzing the at least one data; and
determining an instance of at least one attack on the at least one edge server based on the analyzing of the at least one data, wherein the configuring of the at least one second operational parameter of the plurality of edge servers is further based on the determining of the instance of the at least one attack.

15. The system of claim 14, wherein the analyzing of the at least one data comprises analyzing the at least one data using at least one machine learning model, wherein the at least one machine learning model is trained for detecting at least one of a pattern, a correlation, and an anomaly in the at least one data, wherein at least one of the pattern, the correlation, and the anomaly is indicative of the at least one attack, wherein the determining of the instance of the at least one attack is further based on the detecting.

16. The system of claim 14, wherein the configuring of the at least one first operational parameter of the at least one edge server is further based on the determining of the instance of the at least one attack.

17. The system of claim 16, wherein the at least one edge server is further configured for establishing at least one secure tunnel to the at least one origin server based on the configuring of the at least one first operational parameter, wherein the handling of the at least one traffic between the at least one origin server and the at least one device is through the at least one secure tunnel based on the establishing of the at least one secure tunnel.

18. The system of claim 16, wherein the at least one edge server is further configured for establishing at least one connection to the at least one origin server using at least one subnet of the at least one origin server based on the configuring of the at least one first operational parameter, wherein the handling of the at least one traffic between the at least one origin server and the at least one device is through the at least one connection based on the establishing of the at least one connection.

19. The system of claim 12, wherein the processing device is further configured for:
obtaining at least one first data associated with at least one of the plurality of edge servers;
analyzing the at least one first data; and
determining a condition of at least one of the plurality of edge servers based on the analyzing of the at least one first data, wherein the configuring of the at least one second operational parameter of the plurality of edge servers is further based on the determining of the condition of at least one of the plurality of edge servers.

20. The system of claim 11, wherein the at least one edge server is configured for:
accessing at least one distributed ledger of at least one blockchain based on the configuring of the at least one first operational parameter;
obtaining at least one routing information associated with the at least one edge server based on the accessing;
analyzing the at least one routing information and the at least one traffic;
generating at least one decision associated with the handling of the traffic handling based on the analyzing of the at least one routing information and the at least one traffic, wherein the handling of the at least one traffic is further based on the at least one decision; and
storing the at least one decision in the at least one distributed ledger.
